(19) United States
(12) Patent Application Publication
(10) Pub. No.: US 2016/0350807 A1
(43) Pub. Date: Dec. 1, 2016

(54) OFF-LINE STORE ADVERTISING SERVICE SYSTEM AND METHOD THEREFOR, AND APPARATUS APPLIED THERETO

(71) Applicant: SK PLANET CO., LTD., Seongnam-si (KR)

(72) Inventor: JiHoon SHIN, Seoul (KR)

(73) Assignee: SK PLANET CO., LTD., Seongnam-si (KR)

(21) Appl. No.: 15/111,683

(22) PCT Filed: Dec. 15, 2014
(86) PCT No.: PCT/KR2014/012361

§ 371 Date: Jul. 14, 2016

(30) Foreign Application Priority Data
Jan. 17, 2014 (KR) 10-2014-0006311
Jan. 17, 2014 (KR) 10-2014-0006316
Feb. 12, 2014 (KR) 10-2014-0015943
Mar. 12, 2014 (KR) 10-2014-0028745

(51) Int. Cl. G06Q 30/02; G06F 17/30

(52) U.S. Cl. CPC G06Q 30/0259; G06F 17/3053

(57) ABSTRACT

Disclosed are an off-line store advertising service system and a method therefor, and an apparatus applied thereto. That is, a keyword pre-configured for the off-line store is identified on the basis of a beacon signal associated with the off-line store transmitted from a visitor's terminal, and a display apparatus associated with the keyword displays an advertising/promotional content registered to correspond to the off-line store, thereby providing real time information on the off-line store while effectively promoting the off-line store.

### TECHNICAL FIELD

The present invention relates to a method for reflecting, by a display apparatus adjacently installed to an off-line store, real time information on the off-line store to display an advertising/promotional content, when a visitor's terminal is identified to enter the off-line store on the basis of a beacon signal received by the off-line store.

### BACKGROUND ART

Recently, an advertising service displaying various kinds of advertisement on a display apparatus (digital display Ad machine) in an off-line has been commercialized. The advertising service has been used as an effective store promotion means even by an operator of an off-line store.

Here, to effectively use the advertising service as the off-line store promotion means, it is most important to accurately collect real time information on an off-line store actually in business quantitatively or qualitatively and give the collected real time information to a user.

However, the traditional advertising service has still used a passive scheme using information associated with an off-line store transmitted from an operator or only pre-registered basic information.

Therefore, there is a need for an advertising service method for collecting real time information on an off-line store changed in real time and providing the collected real time information.

### DISCLOSURE

### Technical Problem

An object of the present invention is to identify a keyword pre-set for an off-line store on the basis of a beacon signal associated with the off-line store transmitted from a visitor's terminal and allow a display apparatus associated with the keyword to display an advertising/promotional content registered to correspond to the off-line store, thereby providing real time information on the off-line store while effectively promoting the off-line store.

### Technical Solution

The service apparatus according to a first aspect of the present invention to accomplish the object of the present invention comprises an identification unit configured to identify a keyword for an off-line store on the basis of a beacon signal when the beacon signal received by a visitor's terminal in the off-line store is transmitted; a sorting unit configured to sort a target display apparatus that is a display apparatus associated with the keyword among a plurality of display apparatuses; and a providing unit configured to provide an advertising/promotional content registered in association with the off-line store to display the advertising/promotional content on the target display apparatus.

The keyword for the off-line store includes location information on the off-line store, and the sorting unit sorts display apparatus adjacently located to the off-line store among the plurality of display apparatuses as the target display apparatus on the basis of the location information on the off-line store.

The service apparatus may further include: an updating unit configured to accumulate and update the number of visitors of the off-line store on the basis of the beacon signal transmitted from the visitor's terminal, wherein the advertising/promotional content registered in association with the off-line store is displayed on the target display apparatus only when the number of visitors of the off-line store accumulated and updated for set-up time is equal to or more than a threshold value.

The providing unit may provide, when the number of off-line stores is equal to or more than 2, an advertising/promotional content of a specific off-line store with a larger number of visitors accumulated and updated for the set-up time.

The set-up time may include a plurality of unit set-up times, and the providing unit provides, when the number of visitors entering the at least two off-line stores accumulated and updated for the set-up time is same, the advertising/promotional content of the specific off-line store with a larger number of visitors accumulated and updated for the specific unit set-up time among the plurality of unit set-up times.

The service apparatus may further include: a registration unit configured to register the advertising/promotional content associated with the off-line store, wherein the advertising/promotional content registered in association with the off-line store is displayed on the target display apparatus only when the set-up time from timing registered in the registration unit does not elapse.

An advertisement method in off-line store according to a second aspect of the present invention to accomplish the object of the present invention comprises transmitting, by a visitor's terminal, a beacon signal received by the visitor's terminal in an off-line store to the service apparatus; identifying, by the service apparatus, a keyword for the off-line store on the basis of the beacon signal transmitted from the visitor's terminal; sorting, by the service apparatus, a target display apparatus that is a display apparatus associated with the keyword among a plurality of display apparatuses; and providing, by the service apparatus, an advertising/promotional content registered in association with the off-line store to display the advertising/promotional content on the target display apparatus.

A method of operating a service apparatus according to a third aspect of the present invention to accomplish the object of the present invention comprises: identifying a keyword for an off-line store on the basis of a beacon signal, when the beacon signal received by a visitor's terminal in the off-line store is transmitted from a visitor's terminal; sorting a target display apparatus that is a display apparatus associated with the keyword among a plurality of display apparatuses; and providing an advertising/promotional content registered in association with the off-line store to display the advertising/promotional content on the target display apparatus.

The keyword for the off-line store may include location information on the off-line store, and the sorting comprises sorting display apparatus adjacently located to the off-line store among the plurality of display apparatuses as the target display apparatus on the basis of the location information on the off-line store.

The method may further include: accumulating and updating the number of visitors of the off-line store on the basis of the beacon signal transmitted from the visitor's terminal, wherein the advertising/promotional content registered in association with the off-line store is displayed on the target display apparatus only when the number of visitors of the off-line store accumulated and updated for set-up time is equal to or more than a threshold value.

The providing may comprise providing, when the off-line store is equal to or more than 2, an advertising/promotional content of a specific off-line store with a larger number of visitors accumulated and updated for the set-up time among the at least two off-line stores.

The setup time may include the plurality of unit setup times and the providing comprises providing, when the number of visitors of the at least two off-line stores accumulated and updated for the set-up time is same, the advertising/promotional content of the specific off-line store with a larger number of visitors accumulated and updated for the specific unit set-up time among the plurality of unit set-up times.

The method may further include registering the advertising/promotional content associated with the off-line store, in which the advertising/promotional content registered in association with the off-line store may be displayed on the target display device only when the setup time from the timing registered in the registering does not elapse.

In a fourth aspect of the present invention, an off-line store advertising service system includes: a visitor's terminal transmitting a beacon signal received by the off-line store to a service apparatus; and a service apparatus identifying a keyword configured in the off-line store on the basis of the beacon signal transmitted from the visitor's terminal and sorting a target display apparatus that is a display apparatus associated with the keyword among a plurality of display apparatuses to display the advertising/promotional content registered in association with the off-line store on the target display apparatus.

### Advantageous Effects

According to the off-line store advertising service system and method therefor, and apparatus applied thereto in accordance with the embodiment of the present invention, when the visitor's terminal is identified to enter into the off-line store on the basis of the beacon signal received by the visitor's terminal, the display apparatus adjacently installed to the off-line store may reflect the real time information on the off-line store to display the advertising/promotional content, thereby effectively promoting the off-line store and may provide the real time information on the off-line store to increase the service satisfaction of the viewer of the advertising/promotional content.

### DESCRIPTION OF DRAWINGS

FIG. 1 is a schematic configuration diagram of an off-line store advertising service system according to an embodiment of the present invention.

FIG. 2 is a configuration diagram of a service apparatus according to an embodiment of the present invention.

FIG. 3 is a diagram showing a service screen of an advertising service according to an embodiment of the present invention.

FIG. 4 is a schematic flow chart for describing an operation flow of the off-line store advertising service system according to the embodiment of the present invention.

FIG. 5 is a schematic flow chart for describing an operation process of a service apparatus according to an embodiment of the present invention.

### BEST MODE

Hereinafter, one embodiment of the present invention will be described with reference to the accompanying drawings.

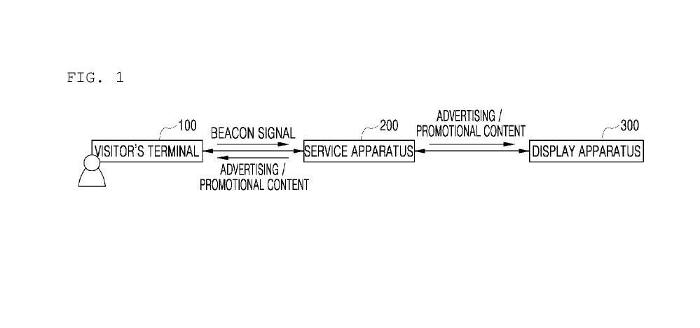

FIG. 1 is a diagram illustrating an off-line store advertising service system according to an embodiment of the present invention.

As illustrated in FIG. 1, the off-line store advertising service system according to the embodiment of the present invention is configured to include a visitor's terminal 100 receiving a beacon signal from an off-line store and transmitting the received beacon signal to a service apparatus 200 and the service apparatus 200 allowing a display apparatus 300 adjacently installed to the off-line store to display an advertising/promotional content of the off-line store.

First, the visitor's terminal 100 is called a mobile apparatus carried by a visitor entering an off-line store.

For example, the visitor's terminal 100 may correspond to a smart phone, a tablet PC, a PDA, etc. but is not limited thereto, and therefore all apparatuses which may receive a beacon signal transmitted from a beacon (not illustrated) kept in an off-line store may be used.

Here, the beacon kept in the off-line store generates RF signals of, for example, a Bluetooth low energy (BLE) signal, a sound wave (for example: including inaudible sound wave and audible sound wave), etc.

The beacon transmits a beacon signal to which a universally unique identifier (UUID) corresponding to an off-line store is allocated.

Meanwhile, according to the embodiment of the present invention, the beacon is just configured to be kept in the off-line store but is not limited thereto. Therefore, the beacon may be configured to be kept in specific outdoor locations (for example: road/distance/attraction which visitors frequently visit) as well as an off-line store.

Further, the service apparatus 200 is called as server for providing an advertising/promotional content associated win an off-line store to the display apparatus 300 and may allow the display apparatus 300 adjacently installed to the off-line store to display the advertising/promotional content registered by an operator of the off-line store.

Here, the advertising/promotional content is a content registered in the service apparatus 200 to allow the operator of the off-line store to promote its own store. For example, the advertising/promotional content may correspond to various contents such as image/location/telephone number/menu/coupon information (for example: QR code) associated with the off-line store.

Further, the display apparatus 300 is called an apparatus which is installed in off-line environment like the off-line store to display the advertising/promotional content provided from the service apparatus 200 to passers-by.

For example, the display apparatus 300 may be an electronic sign, or the like which are installed at an exit and entrance/inside of an off-line store, a bus stop, and an exit and entrance/platform of a subway, or the like which are the off-line environment where easy accessibility and visibility are secured simultaneously.

Meanwhile, according to the embodiment of the present invention, the display apparatus 300 adjacently installed to the off-line store provides an advertising service displaying the advertising/promotional content associated with the off-line store.

For the advertising service, for example, it is general that a passive scheme is used such as a service provider directly surveying the information associated with the off-line store manually or allowing an operator of the off-line store to register an advertising/promotional content for directly promoting himself/herself.

However, it is very difficult for a marketing service provider to survey and manage all the real time information on a large number of off-line stores which are changed frequently and it takes a lot of effort and time for the operator of the off-line store to register his/her own advertising/promotional content in various marketing services one by one.

As such, in promoting the off-line store by maunally collecting or registering the information on the off-line store from the associated advertising service, there may be a limitation in that the real time information on the off-line store changed in real time may not be positively reflected.

Therefore, according to one embodiment of the present invention, a method for reflecting, by a display apparatus 300 adjacently installed to the off-line store, real time information on an off-line store to display an advertising/promotional content, which will be described below in detail.

First, the visitor's terminal 100 serves to transmit a beacon signal.

In more detail, the visitor's terminal 100 may receive the beacon signal from a beacon kept in an off-line store and transmit the received beacon signal to the service apparatus 200, and as a result the service apparatus 200 receiving the beacon signal may recognize that a visitor enters the off-line store.

Further, the visitor's terminal 100 serves to receive an advertising/promotional content associated with the off-line store.

In more detail, the visitor's terminal 100 receives and stores the advertising/promotional content registered to correspond to the off-line store fro the service apparatus 200 receiving the beacon signal or displays the advertising/promotional content on a screen.

Here, the advertising/promotional content received by the visitor's terminal 100 from the service apparatus 200 is information associated with the corresponding off-line store such as a coupon, a discount ticket, a picture, an image, and a store/good guide, but is not limited thereto. Therefore, the advertising/promotional content may include all information for guiding the entrance of the visitor into the off-line store.

Further, the service apparatus 200 serves to register the advertising/promotional content associated with the off-line store.

In more detail, the service apparatus 200 registers the advertising/promotional content received from the operator of the off-line store to correspond to the corresponding off-line store.

In this case, the service apparatus 200 allocates unique identification information to an off-line store, maps the allocated unique identification information to a universally unique identifier of the beacon kept in the off-line store, and then stores it in a database along with the advertising/promotional content.

Further, the service apparatus 200 serves to configure a keyword for the off-line store.

In more detail, the service apparatus 200 configures the keyword corresponding to the off-line store, and as a result, the display apparatus 300 associated with the keyword configured later may display the advertising/promotional content registered to correspond to the off-line store.

In this case, the service apparatus 200 may configure location information on an off-line store as a basic keyword for the off-line store and additionally configure a business condition, a business type, a related search word, or the like of the off-line store along with the location information as a keyword.

Here, when the keyword configuration for the off-line store is completed, the service apparatus 200 identifies the display apparatus 300 adjacently installed to the off-line store among all the display apparatuses 300 installed in the off-line.

Here, the service apparatus 200 identifies a list of the display apparatuses 300 adjacently installed to the off-line store in the whole list of the display apparatuses 300 installed in the off-line, on the basis of the location information configured as the keyword for the off-line store.

As such, identifying the list of the display apparatuses 300 adjacently located to the off-line store is to display the advertising/promotional content of the corresponding off-line store only in the display apparatus 300 adjacently located to the off-line store.

Further, the service apparatus 200 serves to identify an off-line store that a visitor enters.

In more detail, when receiving a beacon signal from the visitor's terminal 100, the service apparatus 200 identifies store identification information mapped to the universally unique identifier included in the corresponding beacon signal to identify that a visitor enters the off-line store corresponding to the identified store identification information.

In this case, if it is identified that a visitor enters an off-line store on the basis of the beacon signal received from the visitor's terminal 100, the service apparatus 200 stores information on timing when the beacon signal is received, that is, timing when the visitor enters the off-line store as real time information, simultaneously with accumulating and updating the number of visitors entering the corresponding off-line store.

Further, the service apparatus 200 serves to display the advertising/promotional content on the display apparatus 300.

In more detail, the service apparatus 200 sorts the display apparatus 300 corresponding to the list of the display apparatuses adjacent to the off-line store that the visitor enters as a target display apparatus for displaying the advertising/promotional content registered to correspond to the off-line store.

In this case, if the target display apparatus for displaying the advertising/promotional content is sorted, the service apparatus 200 provides the advertising/promotional content registered to correspond to the off-line store to the sorted display apparatus 300 to display the advertising/promotional content provided from the display apparatus receiving the registered advertising/promotional content.

Here, the service apparatus 200 simultaneously provides the number of visitors accumulated and updated and the real time information on each off-line store corresponding to the information on the timing when the visitor enters the off-line store, and as a result, the display apparatus 300 displays the real time information together with the advertising/promotional content of the off-line store.

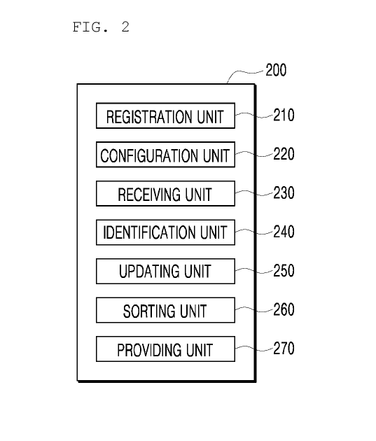

Hereinafter, the configuration of the service apparatus 200 according to the embodiment of the present invention will be described in more detail with reference to FIG. 2.

That is, the service apparatus 200 according to the embodiment of the present invention is configured to include a registration unit 210 registering the advertising/promotional content of the off-line store, a configuration unit 220 configuring the keyword for the off-line store, a receiving unit 230 receiving the beacon signal from the visitor's terminal 100, an identification unit 240 identifying the off-line store on the basis of the beacon signal, an updating unit 250 accumulating and updating the number of visitors entering the off-line store, a sorting unit 260 sorting the display apparatus 300 for displaying the advertising/promotional content, and a providing unit 260 providing the advertising/promotional content to the display apparatus 300.

Here, the whole or a part of the configuration of the foregoing service apparatus 200 may be implemented in a software module form or hardware that is executed by a processor or may be implemented by a combination thereof.

First, the registration unit 210 serves to register the advertising/promotional content of the off-line store.

In more detail, the registration unit 210 registers the advertising/promotional content received from the operator of the off-line store to correspond to the corresponding off-line store.

In this case, the registration unit 210 allocates the unique identification information to the off-line store, maps the allocated unique identification information to the universally unique identifier of the beacon kept in the off-line store, and then store it in a database along with the advertising/promotional content to be registered as the advertising/promotional content corresponding to the off-line store.

Here, the advertising/promotional content is provided to the visitor's terminal 100 transmitting the beacon signal as well as the display apparatus 300 adjacent to the off-line store.

Therefore, the advertising/promotional content registered to correspond to the off-line store may be registered as different advertising/promotional contents corresponding to the visitor's terminal 100 and the display apparatus 300, respectively.

Further, the configuration unit 220 serves to configure the keyword for the off-line store.

In more detail, the configuration unit 220 configures the keyword corresponding to the off-line store, and as a result, the display apparatus 300 associated with a keyword configured later may display the advertising/promotional content registered to correspond to the off-line store.

In this case, the configuration unit 220 may configure the location information on the off-line store as the basic keyword for the off-line store and additionally configure the business condition, the business type, the related search word, or the like of the off-line store along with the location information as the keyword.

For example, when the keyword associated with ‘coffee house A’ that is an off-line store located at ‘hongik university’ is configured, the ‘hongik university’ corresponding to the location information is configured as the basic keyword of the coffee house A and a ‘coffee shop’ based on a business type of an off-line store may be configured as an additional keyword of the ‘coffee house A’.

Here, a plurality of keywords may be overlappingly configured in one off-line store. On the contrary, one keyword may be commonly configured as keywords for a plurality of off-line stores.

For example, in the case of the ‘coffee house A’ located at the ‘hongik university’, ‘hongik university’ and ‘coffee shop’ may be configured as the keyword. The keywords associated with the ‘hongik university’ and ‘coffee shop’ may be configured as the a keyword for a plurality of coffee houses located at the ‘hongik university’ as well as the coffee house A.

Further, the configuration unit 220 serves to identify the display apparatus 300 adjacent to the off-line store.

In more detail, if the keyword configuration for the off-line store is completed, the configuration unit 220 identifies the display apparatus 300 adjacently installed to the off-line store among all the display apparatuses 300 installed in the off-line.

Here, the configuration unit 220 identifies the list of the display apparatuses 300 adjacently installed to the off-line store in the whole list of the display apparatuses 300 installed in the off-line, on the basis of the location information configured as the keyword for the off-line store.

For example, when ‘hongik university’ and ‘coffee shop’ are configured as the keyword of the ‘coffee house A’ located at the ‘hongik university’, only the display apparatus 300 installed near the ‘hongik university’ in the whole list of the pre-registered display apparatus 300 is sorted, and as a result, the sorted display apparatus 300 is managed by being identified as the list of the adjacent display apparatuses of the ‘coffee house A’.

Here, the list of the adjacent display apparatuses of the respective off-line stores includes address information (for example: MAC, IP) on the respective display apparatus 300.

Further, the configuration unit 220 registers the configured keyword in the database while mapping the configured keyword together with the store identification information, the universally unique identifier, and the list of the adjacent display apparatuses as the following [Table 1].

TABLE 1

| Store | | Advertising/ | | |
|---|---|---|---|---|
| identi- | | promotional | | List of |
| fication | Universally | content | | adjacent |
| infor- | unique | (URI or | | display |
| mation | identifier | URL) | Keyword | apparatuses |
| Store A | UUID0001 | XXX | Hongik | DA204, DA205, . . . , |
| | | | university, | DA300 |
| | | | Coffee | |
| | | | shop | |
| Store B | UUID0002 | YYY | Hongik | DA204, DA205, . . . , |
| | | | university, | DA300 |
| | | | Coffee | |
| | | | shop | |
| Store C | UUID0003 | ZZZ | Hongik | DA204, DA205, . . . , |
| | | | university, | DA300 |
| | | | Coffee | |
| | | | shop | |

Further, the identification unit 240 serves to identify the off-line store that a visitor enters.

In more detail, when the receiving unit 230 receives the beacon signal transmitted from the visitor's terminal 100, the identification unit 240 identifies the store identification information mapped to the universally unique identifier included in the corresponding beacon signal to identify that a visitor enters the off-line store corresponding to the identified store identification information.

In this case, if it is identified that the visitor enters the off-line store on the basis of the beacon signal received from the visitor's terminal 100, the updating unit 250 stores the information on the timing when the beacon signal is received, that is, the timing when the visitor enters the off-line store as the real time information, simultaneously with accumulating and updating the number of visitors entering the corresponding off-line store.

Further, the sorting unit 260 serves to sort the display apparatus 300 for displaying the advertising/promotional content.

In more detail, if it is identified that the visitor enters the off-line store, the sorting unit 260 sorts the display apparatus 300 corresponding to the list of the display apparatuses adjacent to the off-line store as the target display apparatus for displaying the advertising/promotional content registered to correspond to the off-line store.

Further, the providing unit 270 serves to provide the advertising/promotional content.

In more detail, if the target display apparatus for displaying the advertising/promotional content is sorted, the providing unit 270 provides the advertising/promotional content registered to correspond to the off-line store to the sorted display apparatus 300 to display the advertising/promotional content provided from the display apparatus receiving the registered advertising/promotional content.

Here, as a method for providing an advertising/promotional content, both of a push method for extracting the registered advertising/promotional content and directly providing the extracted advertising/promotional content to the display apparatus 300 and a pull method for guiding an access of the display apparatus 300 to take back the registered advertising/promotional content are possible.

In addition, the providing unit 270 simultaneously provides the number of visitors accumulated and updated and the real time information on each off-line store corresponding to the information on the timing when the visitor enters the off-line store, and as a result, the display apparatus 300 displays the real time information together with the advertising/promotional content of the off-line store.

In this case, the providing unit 270 sets set-up periods (for example: minute unit, hour unit, day unit, week unit) to display the advertising/promotional content at a specific period, and as a result, the display apparatus 300 may display the advertising/promotional content at each set-up period.

To this end, the providing unit 270 updates and provides the advertising/promotional content to be displayed on the specific display apparatus 300 on the basis of the set-up period or maps a display control policy including the set periods to the advertising/promotional content itself while the advertising/promotional content is registered in the registration unit 210 and register the display control policy, and as a result, the display apparatus 300 may repeatedly display the advertising/promotional content at the set period on the basis of the display policy mapped to the advertising/promotional content.

Meanwhile, when providing the advertising/promotional content of the off-line store, the providing unit 270 provides the advertising/promotional content only when the number of visitors entering the corresponding off-line store is equal to or more than a threshold value.

As such, providing the advertising promotional content only when the number of visitors entering the off-line store is equal to or more than the threshold value is to discriminate visitors' preference for the off-line store. If the number of visitors is equal to or more than the threshold value, it is discriminated that the visitors' preference is high to provide the advertising/promotional content of the corresponding off-line store.

Further, if it is identified that visitors enter a plurality of off-line stores in which the same keyword is configured, the providing unit 270 provides the advertising/promotional content according to priority based on the number of visitors entering the respective off-line stores.

For example, in the case of displaying the advertising/promotional content for the off-line store having ‘hongik university’ and ‘coffee shop’ as the keywords, the off-line store in which the basic keyword based on the location information called the ‘hongik university’ is configured is preferentially identified and the plurality of off-line stores in which the ‘coffee shop’ as an additional keyword among the keywords is commonly configured may be identified.

Therefore, the providing unit 270 may generate a list of priorities for the off-line store on the basis of various criteria of, for example, an off-line store having the largest number of visitors accumulated to date for the set-up time, the most-used store for last week, or the like on the basis of the real time information on the respective identified off-line stores, that is, the number of visitors accumulated and updated and the information on the timing when visitors enter the off-line store and provide the advertising/promotional content corresponding to the respective off-line stores according to the generated list of the priorities.

In this case, the case in which the number of visitors accumulated and updated for the set-up time is same may be generated.

In this case, the providing unit 270 generates the list of the priorities on the basis of the number of visitors for specific unit set-up time in a plurality of unit set-up times included in the set-up time.

For example, when the number of visitors accumulated and updated for the set-up time corresponding to last week is same, the number of visitors for specific unit set-up time (for example: Saturday) in the unit set-up time corresponding to each day for last week is identified, and as a result, the list of the priorities may be generated according to the identified number of visitors.

Therefore, the display apparatus 300 sequentially displays the advertising/promotional contents provided based on the list of the priorities by the defined time.

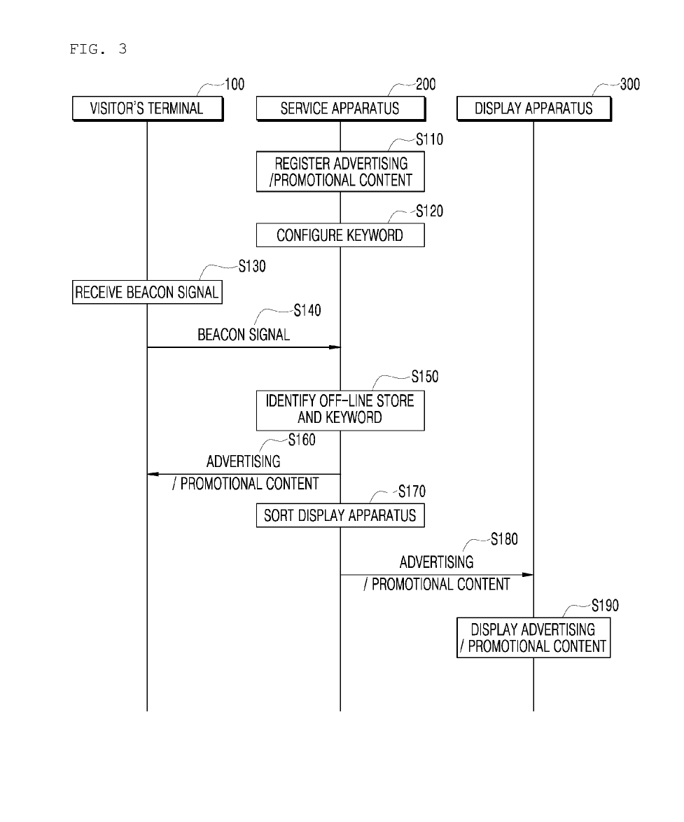

For example, as illustrated in FIG. 3, the display apparatus 300 may display a service screen on which a ranking of restaurants to which visitors prefer is arranged in the ‘hongik university’.

In this case, the display apparatus 300 may display only a ranking of the respective off-line stores according to the priority of the list of the off-line stores or sequentially display the advertising promotional contents associated with the respective off-line stores by the defined time while writing the advertising/promotional contents.

By doing so, passers-by located near the ‘hongik university’ identify ‘off-line store A’ to which visitors most prefer in the ‘hongik university’ at the present point, and as a result, may enter the ‘off-line store A’ based thereon.

In addition, when providing the advertising/promotional content of the off-line store, the providing unit 270 may provide the advertising/promotional content only when the advertising/promotional content registered in association with the off-line store is registered does not pass the set-up time from the registered timing when elapse as well as only when the number of visitors is equal to or more than the threshold value as described above.

As such, providing only the advertising/promotional content which does not pass the set-up time from the registered timing is to increase service satisfaction about an advertising service simultaneously with effectively promoting the off-line store by providing latest information, that is, the real time information on the off-line store.

As described above, according to the off-line store advertising service system in accordance with the embodiment of the present invention, if the visitor's terminal identifies the visitor entrance into the off-line store on the basis of the beacon signal received by the off-line store, the display apparatus adjacently installed to the off-line store may reflect the real time information on the off-line store to display the advertising/promotional content, thereby effectively promoting the off-line store and may provide the real time information on the off-line store to increase the service satisfaction of the viewer of the advertising/promotional content.

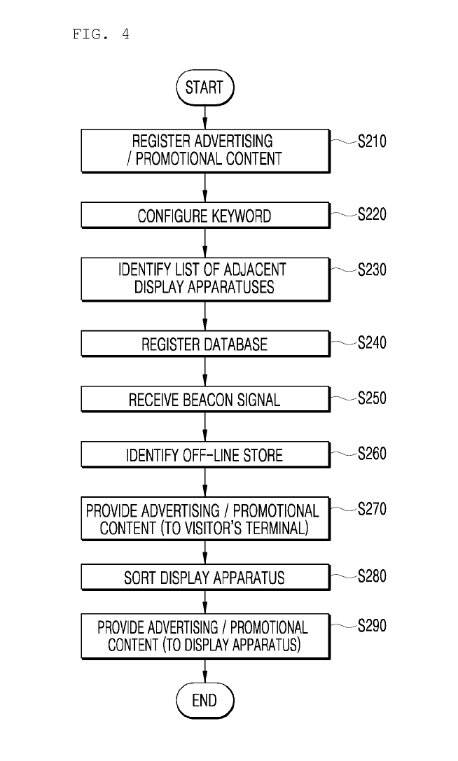

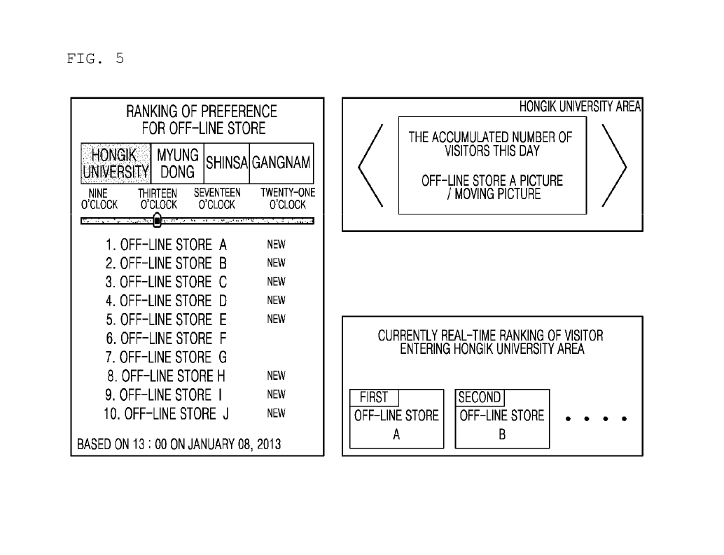

Hereinafter, an advertising service method according to an embodiment of the present invention will be described with reference to FIGS. 4 and 5. Here, for convenience of explanation, the configuration illustrated in FIGS. 1 and 2 as described above will be described by referring to the corresponding reference number.

First, an operation flow in an off-line store marketing service system according to an embodiment of the present invention will be described with reference to FIG. 4.

First, the service apparatus 200 registers the advertising/promotional content received from the operator of the off-line store to correspond to the corresponding off-line store (S110).

In this case, the service apparatus 200 allocates the unique identification information to the off-line store, maps the allocated unique identification information to the universally unique identifier of the beacon kept in the off-line store, and then stores it in a database along with the advertising/promotional content.

In more detail, the service apparatus 200 configures the keyword corresponding to the off-line store, and as a result, the display apparatus 300 associated with the keyword configured later may display the advertising/promotional content registered to correspond to the off-line store (S120).

In this case, the service apparatus 200 may configure the location information on the off-line store as the basic keyword for the off-line store and additionally configure the business condition, the business type, the related search word, or the like of the off-line store along with the location information as the keyword.

Further, if the keyword configuration for the off-line store is completed, the service apparatus 200 identifies the display apparatus 300 adjacently installed to the off-line store among all the display apparatuses 300 installed in the off-line.

Here, the service apparatus 200 identifies the list of the display apparatuses 300 adjacently installed to the off-line store in the whole list of the display apparatuses 300 installed in the off-line, on the basis of the location information configured as the keyword for the off-line store.

Further, the visitor's terminal 100 may receive the beacon signal from the beacon kept in the off-line store and transmit the received beacon signal to the service apparatus 200, and as a result the service apparatus 200 receiving the beacon signal may recognize that a visitor enters the off-line store (S130 and S140).

Therefore, when receiving the beacon signal from the visitor's terminal 100, the service apparatus 200 identifies the store identification information mapped to the universally unique identifier included in the corresponding beacon signal to identify that a visitor enters the off-line store corresponding to the identified store identification information (S150).

In this case, if it is identified that the visitor enters the off-line store on the basis of the beacon signal received from the visitor's terminal 100, the service apparatus 200 stores the information on the timing when the beacon signal is received, that is, the timing when the visitor enters the off-line store as the real time information, simultaneously with accumulating and updating the number of visitors entering the corresponding off-line store.

Next, the service apparatus 200 transmits the advertising/promotional content registered to correspond to the off-line store to the visitor's terminal 100 transmitting the beacon signal and stores the registered advertising/promotional content in the visitor's terminal 100 or displays the registered advertising/promotional content on the screen (S160).

Next, the service apparatus 200 sorts the display apparatus 300 corresponding to the list of the display apparatuses adjacent to the off-line store that the visitor enters as the target display apparatus for displaying the advertising/promotional content registered to correspond to the off-line store (S170).

Next, if the target display apparatus for displaying the advertising/promotional content is sorted, the service apparatus 200 provides the advertising/promotional content registered to correspond to the off-line store to the sorted display apparatus 300 to display the advertising/promotional content provided from the display apparatus receiving the registered advertising/promotional content (S180 and S190).

In this case, the service apparatus 200 simultaneously provides the number of visitors accumulated and updated and the real time information on each off-line store corresponding to the information on the timing when the visitor enters the off-line store, and as a result, the display apparatus 300 displays the real time information together with the advertising/promotional content of the off-line store.

Hereinafter, the operation of the service apparatus 200 according to the embodiment of the present invention will be described in more detail with reference to FIG. 5.

First, the registration unit 210 registers the advertising/promotional content received from the operator of the off-line store to correspond to the corresponding off-line store (S210).

In this case, the registration unit 210 allocates the unique identification information to the off-line store, maps the allocated unique identification information to the universally unique identifier of the beacon kept in the off-line store, and then store it in a database along with the advertising/promotional content to be registered as the advertising/promotional content corresponding to the off-line store.

Next, the configuration unit 220 configures the keyword corresponding to the off-line store, and as a result, the display apparatus 300 associated with a keyword configured later may display the advertising/promotional content registered to correspond to the off-line store (S220).

In this case, the configuration unit 220 may configure the location information on the off-line store as the basic keyword for the off-line store and additionally configure the business condition, the business type, the related search word, or the like of the off-line store along with the location information as the keyword.

Next, if the keyword configuration for the off-line store is completed, the configuration unit 220 identifies the display apparatus 300 adjacently installed to the off-line store among all the display apparatuses 300 installed in the off-line (S230).

Here, the configuration unit 220 identifies the list of the display apparatuses 300 adjacently installed to the off-line store in the whole list of the display apparatuses 300 installed in the off-line, on the basis of the location information configured as the keyword for the off-line store.

Further, the configuration unit 220 registers the configured keyword in the database while mapping the configured keyword together with the store identification information, the universally unique identifier, and the list of the adjacent display apparatuses (S240).

Further, when the receiving unit 230 receives the beacon signal transmitted from the visitor's terminal 100, the identification unit 240 identifies the store identification information mapped to the universally unique identifier included in the corresponding beacon signal to identify that a visitor enters the off-line store corresponding to the identified store identification information (S250 and S260).

In this case, if it is identified that the visitor enters the off-line store on the basis of the beacon signal received from the visitor's terminal 100, the updating unit 250 stores the information on the timing when the beacon signal is received, that is, the timing when the visitor enters the off-line store as the real time information, simultaneously with accumulating and updating the number of visitors entering the corresponding off-line store.

Next, the providing unit 260 provides the advertising/promotional content registered to correspond to the off-line store that the visitor enters to the visitor's terminal 100 transmitting the beacon signal as a target (S270).

Next, if it is identified that the visitor enters the off-line store, the sorting unit 260 sorts the display apparatus 300 corresponding to the list of the display apparatuses adjacent to the off-line store as the target display apparatus for displaying the advertising/promotional content registered to correspond to the off-line store (S280).

Next, if the target display apparatus for displaying the advertising/promotional content is sorted, the providing unit 270 provides the advertising/promotional content registered to correspond to the off-line store to the sorted display apparatus 300 to display the advertising/promotional content provided from the display apparatus receiving the registered advertising/promotional content (S290).

In this case, when providing the advertising/promotional content of the off-line store, the providing unit 270 provides the advertising/promotional content only when the number of visitors entering the corresponding off-line store is equal to or more than a threshold value.

Here, if it is identified that visitors enter a plurality of off-line stores in which the same keyword is configured, the providing unit 270 provides the advertising/promotional content according to the priority based on the number of visitors entering the respective off-line stores.

As described above, according to the off-line store advertising service method in accordance with the embodiment of the present invention, if the visitor's terminal identifies the visitor entrance into the off-line store on the basis of the beacon signal received by the off-line store, the display apparatus adjacently installed to the off-line store may reflect the real time information on the off-line store to display the advertising/promotional content, thereby effectively promoting the off-line store and may provide the real time information on the off-line store to increase the service satisfaction of the viewer of the advertising/promotional content.

Meanwhile, the steps of the method or the algorithm described in connection with the embodiments proposed herein may be directly implemented in hardware or implemented in a program command form that may be executed by various computer means to be recorded in a computer-readable medium. The computer-readable recording medium may include a program command, a data file, a data structure or the like, alone or a combination thereof. The program commands recorded in the computer-readable recording medium may be especially designed and constituted for the present invention or be known to those skilled in a field of computer software. An example of the computer readable recording medium may include magnetic media such as hard disk, floppy disk, magnetic tape, and the like, optical media such as CD-ROM, DVD, and the like, magneto-optical media such as floptical disk, and hardware devices specially configured to store and perform program commands such as ROM, RAM, flash memory, and the like. Examples of the program commands may include a high-level language code capable of being executed by a computer using an interpreter, or the like, as well as a machine language code made by a compiler. The hardware device may be constituted to be operated as one more software modules in order to perform the action according to the present invention, and vise versa.

Although the present invention is described in detail with reference to the preferred embodiments, the present invention is not limited to the foregoing embodiments. A person having ordinary skill in the art to which the present invention pertains may variously change or modify the present invention without deviating from the scope of the present invention.

1. A service apparatus, comprising:
an identification unit configured to identify a keyword for an off-line store on the basis of a beacon signal when the beacon signal received by a visitor's terminal in the off-line store is transmitted;
a sorting unit configured to sort a target display apparatus that is a display apparatus associated with the keyword among a plurality of display apparatuses; and
a providing unit configured to provide an advertising/promotional content registered in association with the off-line store to display the advertising/promotional content on the target display apparatus.

2. The service apparatus of claim 1, wherein the keyword for the off-line store includes location information on the off-line store, and
the sorting unit sorts display apparatus adjacently located to the off-line store among the plurality of display apparatuses as the target display apparatus on the basis of the location information on the off-line store.

3. The service apparatus of claim 1, further comprising:
an updating unit configured to accumulate and update the number of visitors of the off-line store on the basis of the beacon signal transmitted from the visitor's terminal,
wherein the advertising/promotional content registered in association with the off-line store is displayed on the target display apparatus only when the number of visitors of the off-line store accumulated and updated for set-up time is equal to or more than a threshold value.

4. The service apparatus of claim 3, wherein the providing unit provides, when the number of off-line stores is equal to or more than 2, an advertising/promotional content of a specific off-line store with a larger number of visitors accumulated and updated for the set-up time.

5. The service apparatus of claim 4, wherein the set-up time includes a plurality of unit set-up times, and
the providing unit provides, when the number of visitors entering the at least two off-line stores accumulated and updated for the set-up time is same, the advertising/promotional content of the specific off-line store with a larger number of visitors accumulated and updated for the specific unit set-up time among the plurality of unit set-up times.

6. The service apparatus of claim 1, further comprising: a registration unit configured to register the advertising/promotional content associated with the off-line store,
wherein the advertising/promotional content registered in association with the off-line store is displayed on the target display apparatus only when the set-up time from timing registered in the registration unit does not elapse.

7. A method of operating a service apparatus, comprising:
identifying a keyword for an off-line store on the basis of a beacon signal, when the beacon signal received by a visitor's terminal in the off-line store is transmitted from a visitor's terminal;
sorting a target display apparatus that is a display apparatus associated with the keyword among a plurality of display apparatuses; and
providing an advertising/promotional content registered in association with the off-line store to display the advertising/promotional content on the target display apparatus.

8. The method of claim 7, wherein the keyword for the off-line store includes location information on the off-line store, and
the sorting comprises sorting display apparatus adjacently located to the off-line store among the plurality of display apparatuses as the target display apparatus on the basis of the location information on the off-line store.

9. The method of claim 7, further comprising:
accumulating and updating the number of visitors of the off-line store on the basis of the beacon signal transmitted from the visitor's terminal,
wherein the advertising/promotional content registered in association with the off-line store is displayed on the target display apparatus only when the number of visitors of the off-line store accumulated and updated for set-up time is equal to or more than a threshold value.

10. The method of claim 9, wherein the providing comprises providing, when the off-line store is equal to or more than 2, an advertising/promotional content of a specific off-line store with a larger number of visitors accumulated and updated for the set-up time among the at least two off-line stores.
